(19) United States
(12) Patent Application Publication
(10) Pub. No.: US 2009/0297688 A1
(43) Pub. Date: Dec. 3, 2009

(54) Aunt Nee's taste of Mexico salsa

(76) Inventors: Lydia Christine Schwager, Garden City, MI (US); Howard Donald Schwager, Garden City, MI (US)

Correspondence Address: LYDIA & HOWARD SCHWAGER, 31711 PIERCE, Garden City, MI, 48135, US

(21) Appl. No.: 12/154,645

(22) Filed: May 27, 2008

(51) Int. Cl. A23L 1/221

(52) U.S. Cl. 426/650

(57) ABSTRACT

With Aunt Nee's dry salsa mix all you need to do is stir in a can of diced tomatoes and you will have an authentic tasting Mexican salsa, anywhere and anytime.

Written description of the invention. A dry spice packet with instructions to make authentic Mexican salsa.

The manner and process of making and using the same. The dry spice packet is made through an exact measurement process of ten (10) ingredients which total between 0.5 to 1.0 ounces depending on the hotness. There are five (5) levels of hotness: “Not Hot”; “Mild”; “Medium”; “Hot”; and “TNT”. You thoroughly mix the spice packet in a small bowl with approximately a pound of diced canned or freshly diced tomatoes or mix in a blender for 5 seconds. Chill in the refrigerator for 5-10 minutes and serve with tortilla chips.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Co-inventor Lydia Schwager, originally known as “Aunt Lee Lee” came from a very large and proud Mexican family. Not satisfied with American versions of salsa we decided to create an authentic Mexican salsa and after a trip to Mexico. Our goal was to create a no-brainer salsa mix for every taste that could simply be made anywhere at anytime.

When she was younger and cared for the first generation of nieces and nephews, she acquired this name. Her baby sister is 10 years younger than her. While attending college, her baby sister attended to their son and cared for him with much love and giving of herself. Ten-years later we did the same for her. Her first born, was a son born mildly autistic and 18 months later came a little baby girl. The little girl began speaking very early and before her autistic brother. The little sister often helped her older brother with words that he simply did not care to pronounce like “Aunt Lee Lee”. Lydia's new niece has a lisp and could not pronounce her “L's” which turned into “N's” and that is how Aunt Lydia became “Aunt Nee.” Both children latched onto this name which Lydia is very proud to have.

Prior to a loss of employment, we celebrated our 2^{th} wedding anniversary with a trip to Mexico. It was then we both became interested in the flavor, texture and consistency of Mexican salsa. While Lydia worked full time and took as much overtime to make ends meet, we spent a lot of time in the kitchen together. We continued to perfect the salsa recipe, taking it to parties and family events and asking for opinions. Both our friends and family loved it and said that it was so good that we should market the salsa.

We always wanted to give something back and our intention is to donate a percentage of proceeds to an autistic organization in honor of Lydia's nephew. Both children are very bright and entertaining individuals and helped us create the “Not Hot” brand.

### BRIEF SUMMARY OF THE INVENTION

We traveled to Mexico and enjoyed the fresh flavor of their foods. We noticed the difference between what is sold here in the United States as “salsa” and what the Mexican people call “salsa.” We spoke with locals and chefs and obtained ideas as to a list of ingredients to make authentic salsa when we returned to the United States. We never found the same recipe twice in Mexico.

### BRIEF DESCRIPTION OF THE SEVERAL VIEWS OF THE DRAWING

“Not Applicable”

### DETAILED DESCRIPTION OF THE INVENTION

After nearly two years of trying different combinations and quantities of ingredients and converting fresh ingredients into dry or dehydrated components we finally perfected the right combination of the ten (10) ingredients. Measurements varied from ⅛ teaspoon to 1 tablespoon of chili powder, cilantro, dried onions, fructose, lime powder, pepper seeds, salt, pepper, cumin and dried garlic.

Our spice packets contain no preservatives.

Our product has a long shelf life not requiring anything other than typical consumer storage associated with spices people keep in their kitchen.

Our product is simple and portable with the ability to be made without any special knowledge or mixing aids.

Included in our mixing and serving instructions is information concerning characteristics of tomatoes regarding spoilage via double dipping and human saliva.

We created recipes for popular Mexican dishes and dips by using our spice packets as seasoning.

I. The only authentic dry Mexican salsa mix you can make anywhere with only a can of diced tomatoes, a fork and a bowl.

II. The only authentic dry Mexican salsa mix with five (5) levels of hotness including one developed especially for kids—our “Not Hot” brand.

III. The only authentic dry Mexican salsa mix you can cook with.
